(19) United States
(12) Patent Application Publication
(10) Pub. No.: US 2010/0115072 A1
(43) Pub. Date: May 6, 2010

(54) NON-NETWORK INITIATED QUALITY OF SERVICE (QoS)

(75) Inventors: Ajith T. Payyappilly, San Diego, CA (US); Srinivasan Balasubramanian, San Deigo, CA (US); Lei Shen, Beijing (CN)

Correspondence Address: QUALCOMM INCORPORATED, 5775 MOREHOUSE DR., SAN DIEGO, CA, 92121, US

(73) Assignee: QUALCOMM, Incorporated, San Diego, CA (US)

(21) Appl. No.: 12/571,762

(22) Filed: Oct. 1, 2009

Related U.S. Application Data
(60) Provisional application No. 61/102,481, filed on Oct. 3, 2008.

(51) Int. Cl. G06F 15/177

(52) U.S. Cl. 709/222

(57) ABSTRACT

Systems and methods for automatically providing different levels of Quality of Service (QoS) to applications in a communication network having various content providers. Typically, content is provided to applications that are unable to specify applicable QoS. A service node is provided to coordinate transfer of data to the applications. The service node further cooperates with an access terminal running the applications to specify the QoS.

### CLAIM OF PRIORITY UNDER 35 U.S.C. §119

The present application for patent claims priority to Provisional Application No. 61/102,481 entitled “Non-Network Initiated Quality of Service (QoS)” filed Oct. 3, 2008, which is assigned to the assignee hereof and is hereby expressly incorporated by reference herein.

### BACKGROUND

1. Field

The present application relates generally to communications, and more specifically to automatically provide different levels of Quality of Service (QoS) for communications in a communication network having different content providers providing content to applications that are unable to specify applicable QoS.

2. Background

Wireless communication systems are widely deployed to provide various types of communication (e.g., voice, data, multimedia services, etc.) to multiple users. Further, such communications may be provided by a variety of sources. Users of mobile devices may run applications that receive communications from these various sources. For some such applications it may be desirable to receive such communication with a certain QoS level. To enable applications to receive such communications with the appropriate QoS levels, new systems and methods for providing an appropriate QoS level are needed.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include supporting guaranteed QoS levels for data content requested by an application that is unable to specify a QoS level.

One embodiment of the disclosure provides a wireless communication apparatus operative in a communication network. The apparatus comprises a processor. The apparatus further comprises circuitry. The circuitry is coupled to the processor. The circuitry and the processor are cooperatively configured to execute an application. The circuitry and the processor are further cooperatively configured to receive content data for the application from a data source. The application is unable to specify a quality of service (QoS) level for receiving said content data from the data source. The circuitry and the processor are further cooperatively configured to specify the QoS level at which the application would receive said content data from the data source. The specified QoS level is based at least in part on an identity of the data source.

Another embodiment of the disclosure provides a method of communicating between a wireless communication device and a data source. The method comprises executing an application. The method further comprises receiving content data for the application from the data source. The application is unable to specify a quality of service (QoS) level for receiving said content data from the data source. The method further comprises specifying the QoS level at which the application would receive said content data from the data source. The specified QoS level is based at least in part on an identity of the data source.

Yet another embodiment of the disclosure provides a wireless communication apparatus operative in a communication network. The apparatus comprises means for executing an application and for receiving content data for the application from a data source. The application is unable to specify a quality of service (QoS) level for receiving said content data from the data source. The apparatus further comprises means for specifying the QoS level at which the application would receive said content data from the data source. The specified QoS level is based at least in part on an identity of the data source.

A further embodiment of the disclosure provides a computer program product comprising computer-readable medium. The computer-readable medium comprises code for causing a computer to execute an application. The computer-readable medium further comprises code for causing a computer to receive content data for the application from a data source. The application is unable to specify a quality of service (QoS) level for receiving said content data from the data source. The computer-readable medium further comprises code for causing a computer to specify the QoS level at which the application would receive said content data from the data source. The specified QoS level is based at least in part on an identity of the data source.

Yet a further embodiment of the disclosure provides a communication apparatus operative in a communication network. The apparatus comprises a receiver. The receiver is configured to receive from a wireless communication device a request for content data from a data source. The wireless communication device is configured to execute an application and receive said content data for the application from the data source. The application is unable to specify a quality of service (QoS) level for receiving said content data from the data source. The apparatus further comprises a processor coupled to the receiver. The processor is configured to associate with the data source a configurable QoS level at which the wireless communication device would receive said content data from the data source. The apparatus further comprises a transmitter coupled to the processor. The transmitter is configured to transmit an indication of the associated QoS level to the wireless communication device. The wireless communication device is configured to specify the QoS level at which the application would receive said content data from the data source based at least in part on the transmitted indication of the associated QoS level.

Another embodiment of the disclosure provides a method of communicating between a wireless communication device and a data source. The method comprises receiving from the wireless communication device a request for content data from the data source. The wireless communication device is configured to execute an application and receive said content data for the application from the data source. The application is unable to specify a quality of service (QoS) level for receiving said content data from the data source. The method further comprises associating with the data source a configurable QoS level at which the wireless communication device would receive said content data from the data source. The method further comprises transmitting an indication of the associated QoS level to the wireless communication device. The wireless communication device is configured to specify the QoS level at which the application would receive said content data from the data source based at least in part on the transmitted indication of the associated QoS level.

Yet another embodiment of the disclosure provides a wireless communication apparatus operative in a communication network. The apparatus comprises means for receiving from a wireless communication device a request for content data from a data source. The wireless communication device is configured to execute an application and receive said content data for the application from the data source. The application is unable to specify a quality of service (QoS) level for receiving said content data from the data source. The apparatus further comprises means for associating with the data source a configurable QoS level at which the wireless communication device would receive said content data from the data source. The apparatus further comprises means for transmitting an indication of the associated QoS level to the wireless communication device. The wireless communication device is configured to specify the QoS level at which the application would receive said content data from the data source based at least in part on the transmitted indication of the associated QoS level.

A further embodiment of the disclosure provides a computer program product comprising computer-readable medium. The computer-readable medium comprises code for causing a computer to receive from a wireless communication device a request for content data from the data source. The wireless communication device is configured to execute an application and receive said content data for the application from the data source. The application is unable to specify a quality of service (QoS) level for receiving said content data from the data source. The computer-readable medium further comprises code for causing a computer to associate with the data source a configurable QoS level at which the wireless communication device would receive said content data from the data source. The computer-readable medium further comprises code for causing a computer to transmit an indication of the associated QoS level to the wireless communication device. The wireless communication device is configured to specify the QoS level at which the application would receive said content data from the data source based at least in part on the transmitted indication of the associated QoS level.

### BRIEF DESCRIPTION OF THE DRAWINGS

FIG. 1 illustrates an exemplary wireless communication network.

FIG. 2 is a functional block diagram of certain communication devices of the communication network of FIG. 1.

FIG. 3 is a functional block diagram of an exemplary access terminal (AT) shown in

FIG. 2.

FIG. 4 is a functional block diagram of an exemplary packet data service node (PDSN) shown in FIG. 2.

FIG. 5 illustrates a table utilized by an exemplary quality of service (QoS) manager shown in FIGS. 2 & 3.

FIG. 6 illustrates exemplary logical data paths for the data pipes between an access terminal (AT) and an access node (AN) of FIG. 2.

FIG. 7 is an exemplary signal flow diagram illustrating signal flow between an access terminal (AT), an access node (AN), and a packet data service node (PDSN) of FIG. 2.

FIG. 8 is flowchart of an exemplary process of transmitting data from a data source to an access terminal (AT) of FIG. 2.

FIG. 9 is a flowchart of an exemplary process of setting up a filter at a packet data service node (PDSN) for transmitting data received from a data source to an access terminal (AT) of FIG. 2.

### DETAILED DESCRIPTION

The word “exemplary” is used herein to mean “serving as an example, instance, or illustration.” Any embodiment described herein as “exemplary” is not necessarily to be construed as preferred or advantageous over other embodiments. The following description is presented to enable any person skilled in the art to make and use the invention. Details are set forth in the following description for purpose of explanation. It should be appreciated that one of ordinary skill in the art would realize that the invention may be practiced without the use of these specific details. In other instances, well known structures and processes are not elaborated in order not to obscure the description of the invention with unnecessary details. Thus, the present invention is not intended to be limited by the embodiments shown, but is to be accorded with the widest scope consistent with the principles and features disclosed herein.

Furthermore, in the following description, for reasons of conciseness and clarity, terminology associated with the 1x Evolved Data Optimized (1xEV-DO) standards, as promulgated under the 3rd Generation Partnership Project 2 (3GPP2) by the International Telecommunication Union (ITU) is used. It should be emphasized that the invention is also applicable to other technologies, such as technologies and the associated standards related to Wideband Code Division Multiple Access (WCDMA), Time Division Multiple Access (TDMA), Orthogonal Frequency Division Multiple Access (OFDMA) and so forth. Terminologies associated with different technologies can vary. For example, depending on the technology considered, the Access Terminal (AT) used in 1xEV-DO standards can sometimes be called a mobile station, a user terminal, a subscriber unit, a user equipment, etc., to name just a few. Likewise, the Access Node (AN) used in 1xEV-DO standards can sometimes be called an access point, a base station, a Node B, and so forth. It should be noted here that different terminologies apply to different technologies when applicable.

Quality of Service (QoS) generally refers to communication performance parameters, such as, a bit rate, delay, jitter, packet dropping probability and/or bit error rate, that a network delivers to an application (e.g., a software module, a set of instructions that may be executed on a processor, etc.). A particular application (e.g., a video decoding application) that runs on a mobile device that accesses a network may require a particular QoS level. The QoS level required by the application refers to a set of values for the QoS parameters that meet the requirements of the application. For example, voice is delay sensitive, so an application using the network for voice may require low latency. Accordingly, the QoS parameters may be set to guarantee the low latency requirement.

In EV-DO networks, support for mobile-initiated or AT-initiated QoS levels is provided. However, some software applications running on an AT are unable to request QoS levels. Accordingly, the AT is unable to initiate a QoS level for the application. In some aspects, the teachings herein include methodologies and systems for implementation of QoS level initiation on networks without resorting to elaborate network revamp and/or standard revisions.

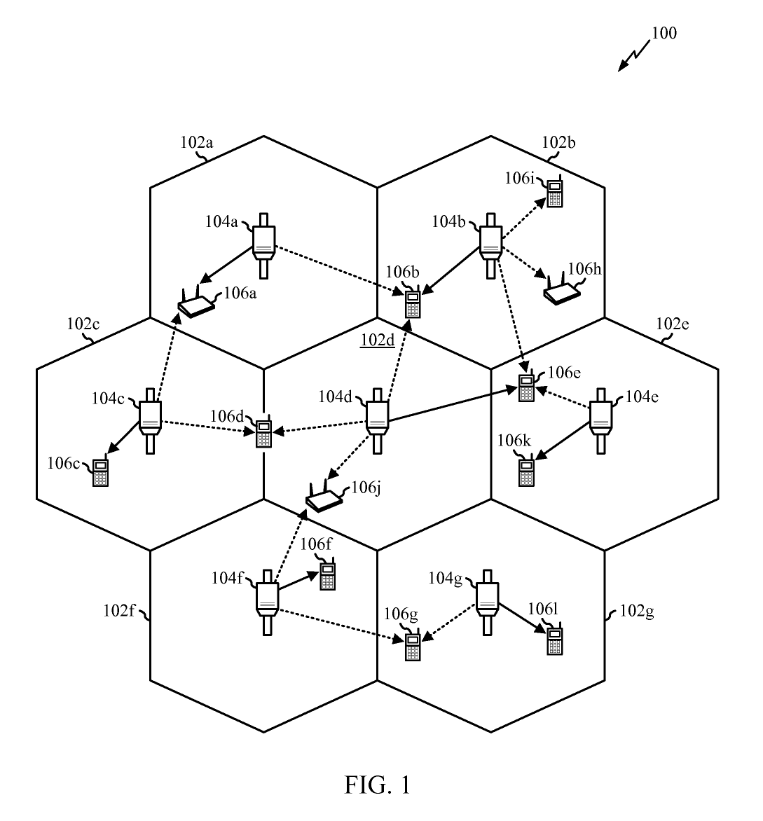

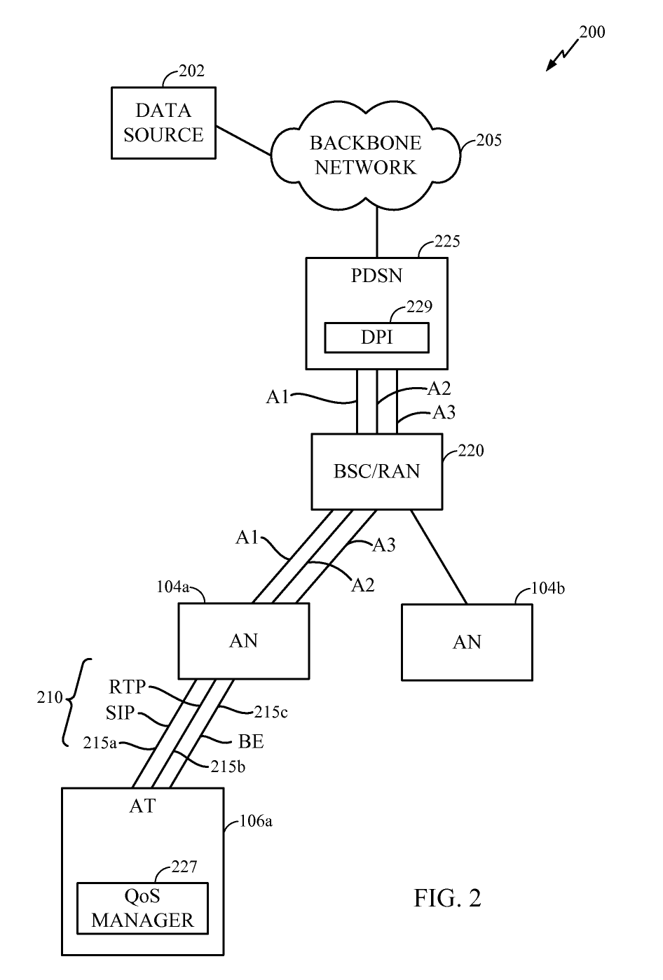

FIG. 1 illustrates an exemplary wireless communication network 100. The wireless communication network 100 is configured to support communication between a number of users. The wireless communication network 100 may be divided into one or more cells 102, such as, for example, cells 102a-102g. Communication coverage in cells 102a-102g may be provided by one or more nodes 104 (e.g., base stations), such as, for example, nodes 104a-104g. Each node 104 may provide communication coverage to a corresponding cell 102. The nodes 104 may interact with a plurality of access terminals (ATs), such as, for example, ATs 106a-106l.

Each AT 106 may communicate with one or more nodes 104 on a forward link (FL) and/or a reverse link (RL) at a given moment. A FL is a communication link from a node to an AT. A RL is a communication link from an AT to a node. The FL may also be referred to as the downlink. Further, the RL may also be referred to as the uplink. The nodes 104 may be interconnected, for example, by appropriate wired or wireless interfaces and may be able to communicate with each other. Accordingly, each AT 106 may communicate with another AT 106 through one or more nodes 104.

The wireless communication network 100 may provide service over a large geographic region. For example, the cells 102a-102g may cover only a few blocks within a neighborhood or several square miles in a rural environment. In one embodiment, each cell may be further divided into one or more sectors (not shown).

As described above, a node 104 may provide an access terminal (AT) 106 access within its coverage area to another communications network, such as, for example the Internet or another cellular network.

An AT 106 may be a wireless communication device (e.g., a mobile phone, router, personal computer, server, etc.) used by a user to send and receive voice or data over a communications network. An access terminal (AT) may also be referred to herein as a user equipment (UE), as a mobile station (MS), or as a terminal device. As shown, ATs 106a, 106h, and 106j comprise routers. ATs 106b-106g, 106i, 106k, and 106l comprise mobile phones. However, each of ATs 106a-106l may comprise any suitable communication device.

FIG. 2 is a functional block diagram of certain communication devices of the communication network of FIG. 1. It may be desirable for an AT 106a to receive data (e.g., data packets for a web browsing session, data packets for a Voice Over IP (VoIP) call, data packets for a video stream, or other data or media content) from one or more data sources such as data source 202 (e.g., a server controlled by a content provider, such as, internet websites provided by CNN®, YAHOO!®, etc.). FIG. 2 illustrates an exemplary embodiment in which the AT 106a may communicate with the data source 202 to receive information.

The AT 106a may send a request seeking data from the data source 202 to the AN 104a. The AT 106a may establish a communication link 210 with the AN 104a. The communication link 210 may be an appropriate wireless link, such as, an airlink. The AT 106a may send the request to the AN 104a via the communication link 210. The AT 106a may comprise a QoS manager module 227. The QoS manager module 227 may be configured to request a particular QoS level for data received from the data source 202 as described in further detail below.

The communication link 210 may comprise one or more data pipes. For example, the communication link 210 may comprise three data pipes 215a, 215b, and 215c. The data pipes 215a-215c may each comprise an airlink that guarantees a different QoS level. It should be noted that link 210 may comprise fewer or greater number of data pipes. Each data pipe 215a-215c may carry data with a particular QoS level. For example, data pipe 215a may carry data for signal initiation protocol (SIP) exchanges. The data pipe 215b may carry radio transport protocol (RTP) data streams, such as data streams of a Voice Over IP (VoIP) call or a video stream. The data pipe 215c may carry best effort (BE) data packets, such as packets in a web browsing session. RTP data packets, which are communicated over data pipe 215b, may require timely delivery of packets. Accordingly, erroneous data packets or lost data packets may not be resent in order to minimize data latency. BE data packets, on the other hand, which are communicated over data pipe 215c, may require accuracy in delivery of data. Accordingly, data packets are resent until the correct data packets are received and acknowledged. Accordingly, each of data pipe 215b and 215c provide a different QoS level. Data pipe 215b provides lower data latency than the data pipe 215c, while data pipe 215c provides higher accuracy than the data pipe 215b.

The AN 104a may receive from the AT 106a the request seeking data from the data source 202. The AN 104a may facilitate communication between the AT 106a and the data source 202 by sending the request for data to a base station controller (BSC) 220 via one or more links A1-A3 (e.g., A10 links). The combination of the BSC 220 and the ANS 104a and 104b is sometimes referred to as a radio access network (RAN). The one or more link A1-A3 may comprise one or more appropriate wired links (e.g., fiber optic cable, copper cable, etc.) and/or wireless links (e.g., airlinks) between the AN 104a and the BSC 220. It should be noted that one or more links A1-A3 may comprise fewer or greater number of links. In one embodiment, each of the links A1-A3 provides a particular QoS level as discussed below. The AN 104a, the BSC 220, and a packet data service node (PDSN) 225 may setup the links A1-A3. For example, the AN 104a and PDSN 225 may exchange communications via the BSC 220 to setup the one or more links A1-A3 between the AN 104a and the PDSN 225 via the BSC 220.

The BSC 220 may receive from the AN 104a the sent request seeking data from the data source 202. The BSC 220 may facilitate communication between the AT 106a and the data source 202 by sending the request for data to the PDSN 225 via the one or more links A1-A3. The one or more link A1-A3 may comprise one or more appropriate wired links (e.g., fiber optic cable, copper cable, etc.) and/or wireless links (e.g., airlinks) between the BSC 220 and the PDSN 225. The BSC 220 may further communicate with one or more additional ANs (e.g., AN 104b) via one or more additional wired links.

The PDSN 225 may receive from the BSC 220 the sent request seeking data from the data source 202. The PDSN 225 may facilitate communication between the AT 106a and the data source 202 by sending the request for data to the network 205 via an appropriate wired (e.g., fiber optic cable, copper cable, etc.) or wireless link (e.g., airlink). In another embodiment, the PDSN 225 may be directly connected to the data source 202 by an appropriate wired or wireless link. The PDSN 225 may comprise a data packet inspection (DPI) module 229. The DPI module 229 may be configured to inspect data packets received from the network 205 and direct them over the appropriate one or more links A1-A3 as described in detail below.

The network 205 may receive from the PDSN 225 the request seeking data from the data source 202. The network 205 may facilitate communication between the AT 106a and the data source 202 by sending the request for data to the data source 202 via an appropriate wired or wireless link. The network 205 may comprise, for example, an intranet or a part of the Internet. In one embodiment, the network 205 operates pursuant to the internet protocol (IP) as promulgated by the Internet Engineering Task Force (IETF). The network may be in communication with one or more additional data sources (not shown).

The data source 202 may receive from the network 205 the request for data. The data source 202 may comprise a server connected to the network 205. The data source 202 may serve data content such as video streams to devices that access the network 205. The AT 106a may access the data source 202 to retrieve video streams or other data as described above. Accordingly, the data source 202 may process the received request and transmit the requested data to the AT 106a via the network 205, the PDSN 225, the BSC 220, and the AN 104a. The choice of links between each of the communication apparatuses described may be based on a QoS level required for transmission of the data from the data source 202 to the AT 106a as discussed below.

In the 1xEV-DO standard, a QoS level for a data packet is initiated by the AT 106a. For example, in one embodiment AT 106a may execute or run one or more applications that provide data content to a user of the AT 106a. The one or more applications may require a different QoS level for different data packets. For example, a first application for streaming video may require a first QoS level, while a second application for browsing the World Wide Web may require a second QoS level.

Further, a given application may require different levels of QoS at different times. For example, the first application for streaming video may have the ability to stream video from one or more data sources (e.g., data source 202). The QoS level required to stream video from each of the one or more data sources may be different. In one embodiment, a data source 202 may require a higher QoS level than another data source (not shown) due to transmission of higher quality video from the data source 202 than from the other data source.

In another embodiment, the network 205 may be controlled by a service provider, such as, a network operator (e.g., Verizon®). The service provider may be, for example, a corporation that allows users of an AT 106a to access the network 205 and data sources connected to the network 205. Further, each data source may be controlled by a different entity such as a corporation. The service provider may therefore contract with the various entities (e.g., content providers) that control the various data sources to provide a particular QoS level to a particular data source. The first application may then require a different QoS level for each data source depending on the QoS level assigned to the data source by the provider.

In one embodiment, a “QoS Aware” application may run on the AT 106a and provide data content to a user of the AT 106a. The QoS Aware application may be able to identify the QoS level needed to request service from the network 205. The QoS Aware application may have logic to request a particular QoS level. For example, the QoS Aware application may have logic to communicate with QoS Application Programming Interfaces (APIs) on the AT 106a. These QoS APIs may be low-level logic or software that allows the AT 106a to request a particular QoS level. Therefore, an application that is QoS Aware may determine it needs a particular QoS level and communicate with the QoS APIs to request that QoS level. The AT 106a running the QoS Aware application may then configure the QoS level by exchanging EV-DO signaling messages with the AN 104a specifying a particular QoS level. The AN 104a and PDSN 225 may then setup the first link A1 (e.g., an A10 link) with the appropriate QoS level as discussed above. The PDSN 225 may then direct packets to the AN 104a over the setup first link A1 to achieve the appropriate QoS level. Further, the AN 104a may direct packets to the AT 106a over the appropriate data pipe 215a-215c to achieve the appropriate QoS level.

In contrast, in one embodiment, the first application may not be able to identify the QoS level needed to request service from the network 205. For example, the first application may be a third party application (e.g., not provided by the manufacturer of the AT 106a) that does not contain the logic to request a particular QoS level. The first application may therefore be referred to as “QoS Unaware” or “QoS Ignorant.” Accordingly, methods and systems are described herein to allow a QoS Unaware application to attain a QoS level without modification of the application. For example, the AT 106a described below is configured to allow QoS Unaware applications to attain a QoS level.

In one embodiment that AT 106a may request a QoS level with the network 205 for a QoS Unaware application as follows. As discussed above, the AT 106a may setup the communication link 210 with the AN 104a. The communication link 210 may initially comprise a first data pipe 215a for carrying BE data packets. The AN 104a and the PDSN 225 may further setup the first link A1 via the BSC 220. The first link A1 may support a QoS level corresponding to a link for carrying BE data packets. The QoS Unaware application running on the AT 106a may then request data from the data source 202 on the network 205 via the first data pipe 215a, the first link A1, and the PDSN 225 as discussed above. Since the first application is QoS Unaware, the data packets may initially be sent using a BE QoS level. Further, the initial communication may not identify a particular QoS level.

Continuing, the PDSN 225 receives the data packets for the AT 106a from the data source 202 via the network 205. As discussed above, the PDSN 225 comprises the DPI module 229. The DPI module 229 may comprise a list of data sources (e.g., content providers) each matched to an indication of a QoS level. The DPI module 229 may be configured to inspect data packets received via the network 205. The DPI module 229 may detect a data packet (e.g., an IP packet) comprising an indicator (e.g., an IP address) that uniquely identifies the source (i.e., the data source 202) of the data packet. The DPI module 229 may determine that the data packets from data source 202 require a particular QoS level. The DPI module 229 may then mark the data packets from the data source 202 with an indication of the appropriate QoS level. For example, the DPI module 229 may mark a TypeOfService (TOS) field of each of the data packet's header with a differentiated service code point (DSCP) value, which indicates to the AT 106a a QoS level required for the data packet from the data source 202. The DPI module 229 may determine the source of the data packet by inspecting the unique indicator associated with the data packet. For example, the DPI module 229 may mark data packets from the data source 202 with the DSCP value D1 after identifying the unique indicator of the data source 202 in the data packets. Further, the DPI module 229 may not mark the TOS field for data packets not in the list of data sources. It should be noted that data packets from different sources may each be marked with the same DSCP value.

The PDSN 225 sends the marked data packets received from the data source 202 to the AT 106a via the first link A1 and the first data pipe 215a. As discussed above, the AT 106a comprises the QoS manager module 227. The QoS manager module 227 inspects the marked data packets. The QoS manager module 227 may then trigger the AT 106a to request the appropriate QoS level for data packets from the data source 202. For example, the QoS manager module 227 may comprise a mapping list. In one embodiment, the mapping list may comprise a list of indications of QoS levels (e.g., DSCP values) to parameters (e.g., profile identifiers), which represent levels of QoS. For example, the QoS manager module 227 may detect the DSCP value D1 (e.g., any arbitrary value) on the received data packet. The QoS manager module 227 may map the DSCP value D1 to a profile identifier P1 indicating a particular QoS level. In one embodiment, each profiles identifier may comprise a different value such as 0x30d, 0x30e, 0x30f, etc., which respectively represent 48 kbps, 64 kbps, and 96 kbps streaming video levels of QoS as specified in standard TSB-58 of the 3GPP2 specification.

The AT 106a may then configure a data pipe (e.g., data pipe 215b) with the AN 104a on the communication link 210 to satisfy the QoS level for transport of data packets with the DSCP value D1. In another embodiment, the AT 106a may pre-configure a plurality of data pipes 215a-215c with the AN 104a when the AT 106a powers up. Each of these data pipes 215a-215c may support a different QoS level and may be reserved when the AT 106a powers up but are not active until data is transmitted over the data pipe.

The AT 106a may then transmit a message (e.g., an RSVP message) to the PDSN 225 via at least one configured data pipe (e.g., data pipe 215a) of the communication link 210 and the first link A1. The RSVP message may comprise an indication of a filter for the PDSN 225 to send data packets from a particular source (e.g., with a particular DSCP value) to the AT 106a over a link that supports the appropriate QoS level. For example, the AT 106a may indicate in the RSVP message a mapping of the DSCP value D1 to the profile identifier P1. In another embodiment, the RSVP message may comprise a mapping of the DSCP value D1 to a reservation label R1 which directly corresponds to the profile identifier P1. In one embodiment, in response to the RSVP message, the PDSN 225 and the AN 104a setup a second link A2 (e.g., another A10 link) that supports a QoS level associated with the profile identifier P1. In another embodiment, the PDSN 225 and the AN 104a may pre-configure a plurality of links A1-A3 corresponding to the data pipes setup between the AT 106a and the AN 104a when the AT 106a powers up. Each of these plurality of links A1-A3 may support a different QoS level and may be reserved when the AT 106a powers up but are not active until data is transmitted over the link.

Further, in response to the RSVP message, the PDSN 225 sets up a filter that directs packets assigned the value D1 by the DPI module 229 (e.g., packets from the data source 202) over the second link A2 and the data pipe 215b. In one embodiment, the reservation label R1 of the RSVP message directly maps to the communication link used to direct packets from the data source 202 to the AT 106a. For example, the reservation label R1 may directly correspond to the communication link comprising the second link A2 and the data pipe 215b. Accordingly, when the DPI module 229 inspects incoming packets and detects a packet that should be assigned the value D1, the DPI module 229 with the filter setup directs the PDSN 225 to transmit the data packets over the second link A2. The PDSN 225 further directs the AN 104a to send the data packets to the AT 106a via the data pipe 215b. The data transmission over the second link A2 and the data pipe 215b achieves the QoS level requested by the QoS manager 227. Accordingly, the QoS Unaware application running on the AT 106a receives data from the data source 202 with the appropriate QoS level without ever requesting a particular QoS level. Similarly, additional links may be setup for additional applications and/or data sources.

One of ordinary skill in the art will recognize that other similar techniques may be used for reserving a QoS level. For example, in another embodiment, the QoS manager module 227 may include a mapping of data sources to QoS levels and the AT 106a may directly request an appropriate QoS level without having to receive such information from the PDSN 225. One benefit of mapping at the PDSN 225 is that the mapping of data sources to QoS levels can be reconfigured by the service provider by changing the list in the DPI module 229. Accordingly, the service provider does not have to change the list in each QoS manager module 227 of each AT in order to change the QoS level for a particular data source.

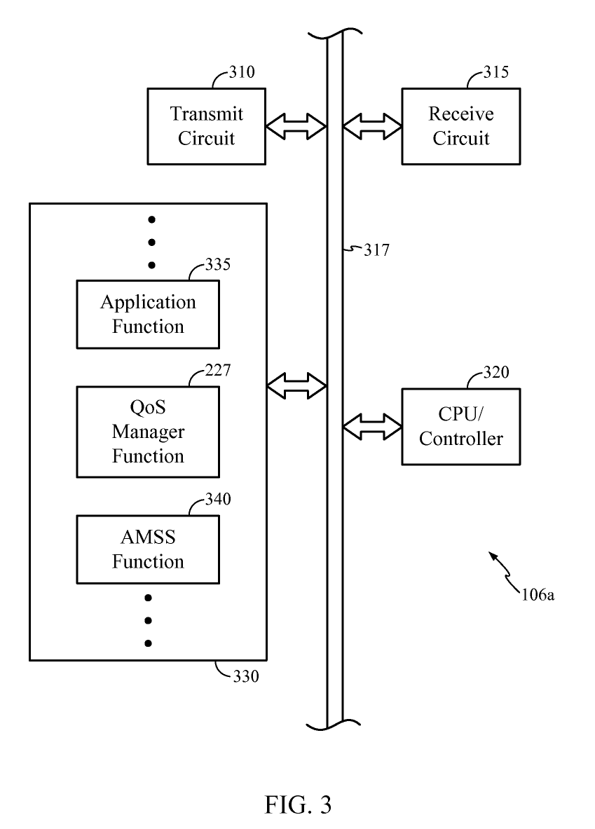

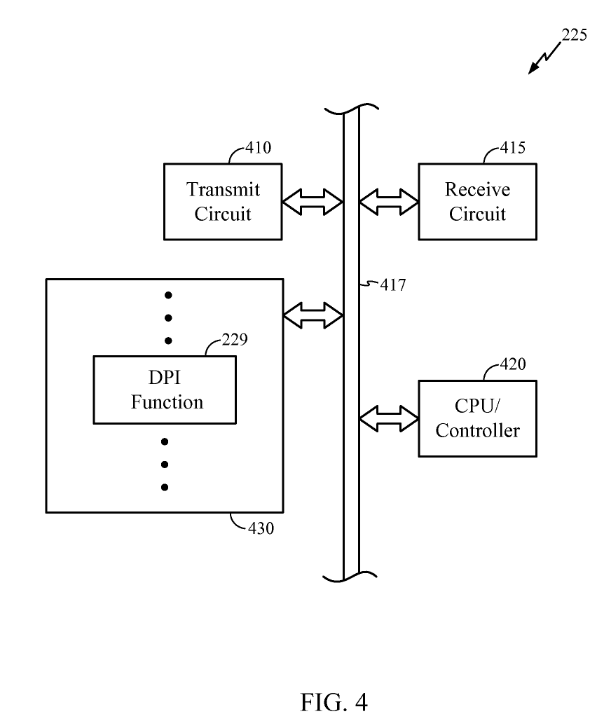

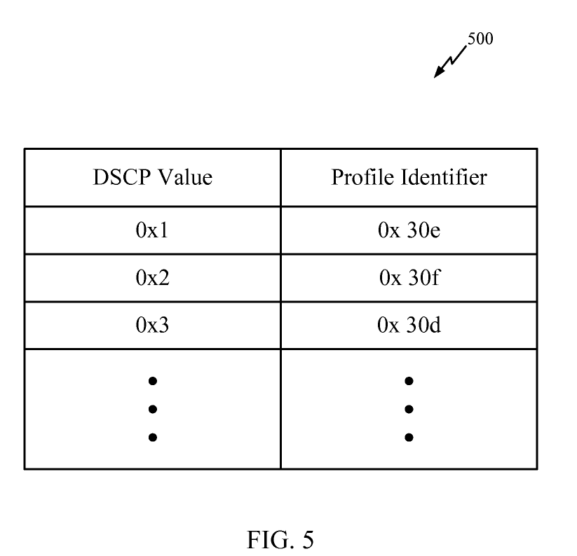

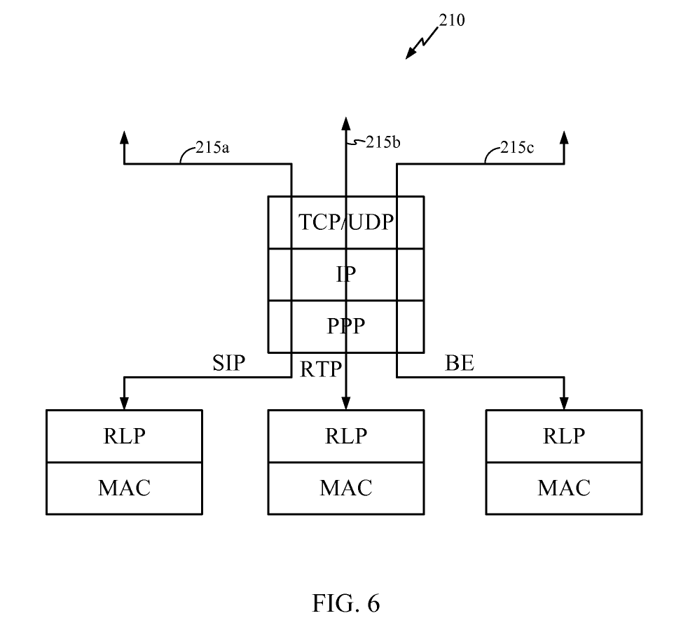

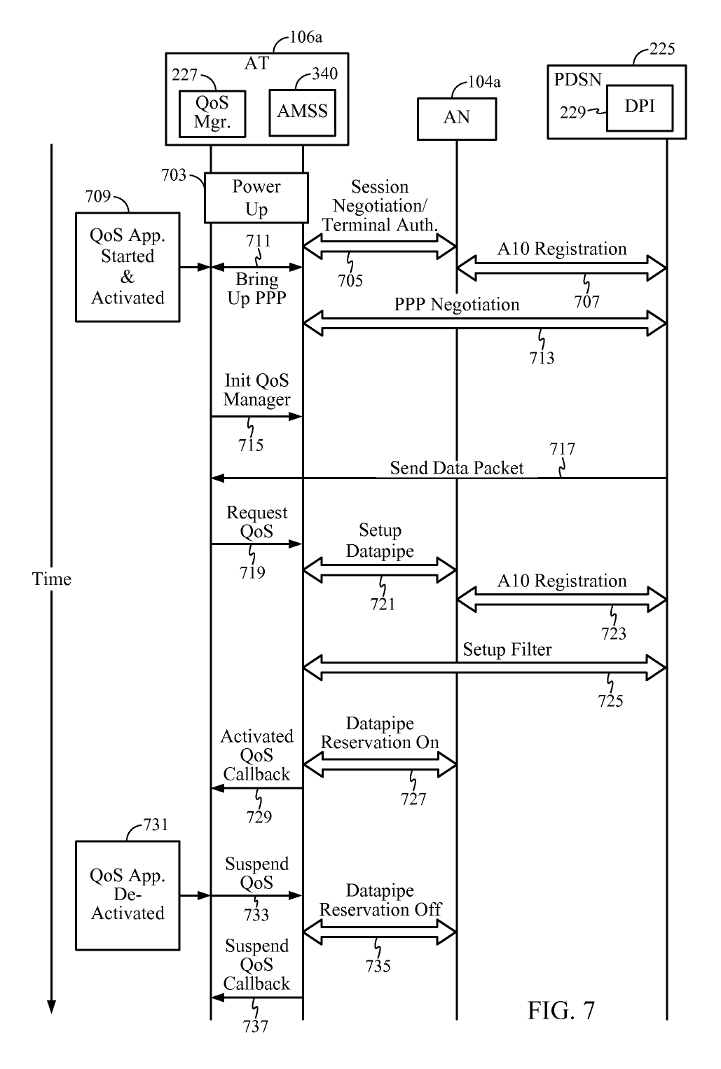

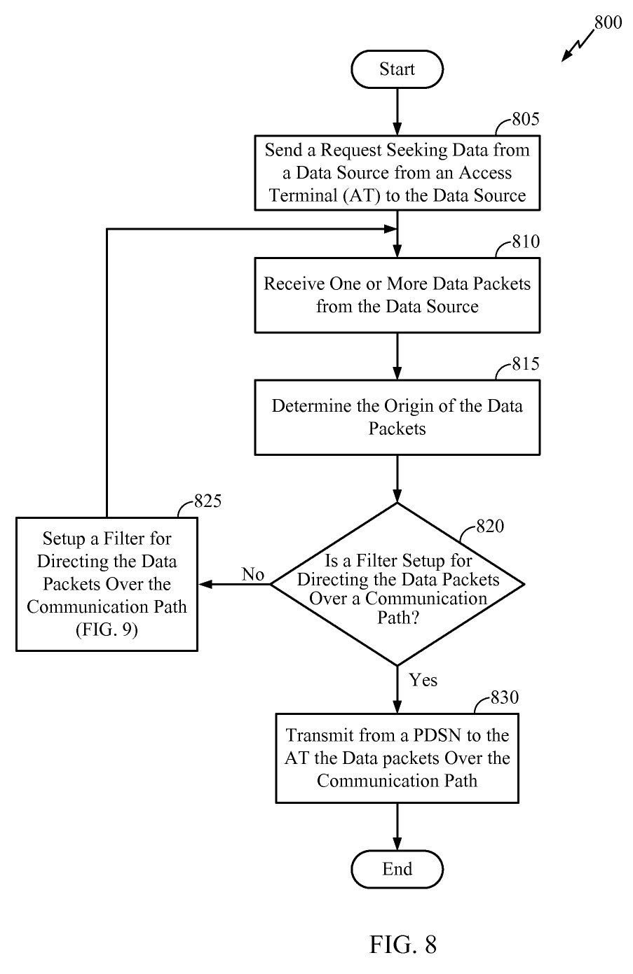

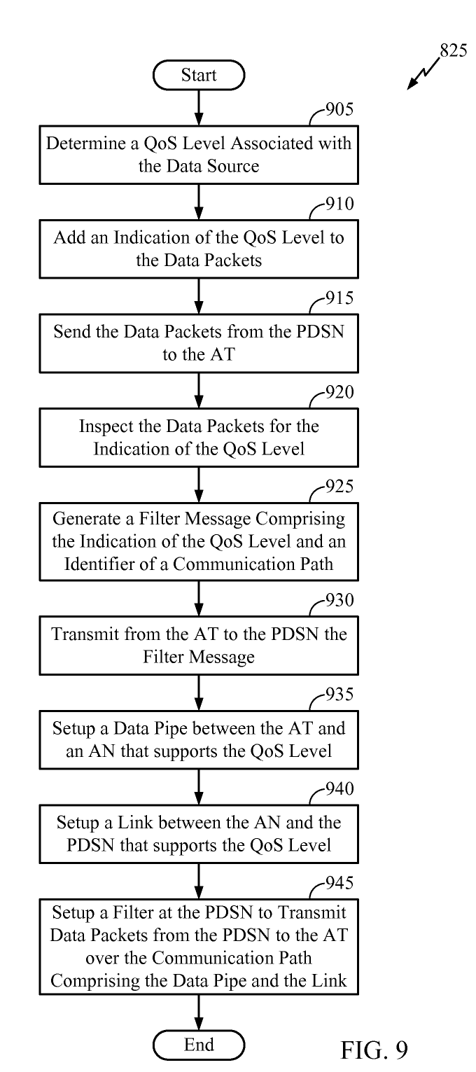

FIG. 3 is a functional block diagram of an exemplary access terminal 106a shown in FIG. 2. As discussed above with respect to FIG. 2, the AT 106a may communicate with the AN 104a to receive data from the data source 202 by sending a request for data to the data source 202 via the AN 104a. The AT 106a may comprise a transmit circuit 310 configured to transmit an outbound message, such as a request for data from the data source 202, to the AN 104a. The AT 106a may further comprise a receive circuit 315 configured to receive an incoming message, such as a data packet from the data source 202, from the AN 104a. The transmit circuit 310 and the receive circuit 315 may be coupled to a central processing unit (CPU)/controller 320 via a bus 317. The CPU 320 may be configured to process the inbound and outbound messages coming from or going to the AN 104a. The CPU 320 may also be configured to control other components of the AT 106a.

The CPU 320 may further be coupled to a memory 330 via the bus 317. The CPU 320 may read information from or write information to the memory 330. For example, the memory 330 may be configured to store inbound or outbound messages before, during, or after processing. The memory 330 may also comprise instructions or functions for execution on the CPU 320. For example, the memory 330 may comprise an application function 335, the QoS manager function 227, and an advanced mode subscriber software (AMSS) function 340. The operation of the CPU 320 executing each of these functions is described below.

The application function 335 may comprise instructions executable on the CPU 320 that when executed cause the CPU 320 of the AT 106a to process incoming data packets. For example, the application function 335 may comprise a video player application that requests and receives video data packets from the data source 202 as described above with respect to FIG. 2. The CPU 320 executing the application function 335 may process the incoming video packets in order to generate a video for a user of the AT 106a to view.

The QoS manager function 227 may comprise instructions executable on the CPU 320.

When executed, the QoS manager function 227 may cause the CPU 320 of the AT 106a to request a QoS level for receiving data packets from the data source 202 as discussed above with respect to FIG. 2. In one embodiment, the CPU 320 executing the QoS manager 227 processes or inspects incoming data packets to check if the data packets comprise a DSCP value. The QoS manager 227 further comprises a table stored in the memory 330. If the CPU 320 executing the QoS manager 227 detects a DSCP value, the CPU 320 accesses the table stored in the memory 330 to find the profile identifier associated with the DSCP value. The QoS manager 227 may direct the AMSS function 340 running on the CPU 320 to generate a filter message to send to the PDSN 225 to setup a filter at the PDSN 225 as discussed above with respect to FIG. 2.

The AMSS function 340 may comprise instructions executable on the CPU 320. The AMSS function 340 may act as an operating system driving the AT 106a. For example, the QoS manager may interact with the AMSS function 340 to generate the filter message to setup the filter at the PDSN 225. In one embodiment, the filter message may comprise the DSCP value received in the data packet from the data source 202. Further, the filter message may comprise the profile identifier associated with the DSCP value. In another embodiment, the filter message may comprise the DSCP value and a reservation label. The reservation label may directly correspond to a communication link that provides the QoS level associated with the profile identifier associated with the DSCP value. The CPU 320 may send the filter message to the transmit circuit 310 via the bus 317. The transmit circuit 310 may transmit the filter message to the AN 104a to send to the PDSN 225. Further, the AMSS function may comprise a radio frequency (RF) module, wireless protocol stack software used under different technologies and/or standards, etc.

The transmit circuit 310 may comprise a modulator configured to modulate outbound message going to the AN 104a. The receive circuit 315 may comprise a demodulator configured to demodulate inbound messages coming from the AN 104a.

The memory 330 may comprise processor cache, including a multi-level hierarchical cache in which different levels have different capacities and access speeds. The memory 330 may also comprise random access memory (RAM), other volatile storage devices, or non-volatile storage devices. The storage may include hard drives, optical discs, such as compact discs (CDs) or digital video discs (DVDs), flash memory, floppy discs, magnetic tape, Zip drives, etc.

Although described separately, it is to be appreciated that functional blocks described with respect to the AT 106a need not be separate structural elements. For example, the CPU 320 and the memory 330 may be embodied on a single chip. The CPU 320 may additionally, or in the alternative, contain memory, such as processor registers. Similarly, one or more of the functional blocks or portions of the functionality of various blocks may be embodies on a single chip. Alternatively, the functionality of a particular block may be implemented on two or more chips.

One or more of the functional blocks and/or one or more combinations of the functional blocks described with respect to the AT 106a, such as the CPU 420, the application function 335, the QoS manager 227, and the AMSS function 340, may be embodied as a general purpose processor, a digital signal processor (DSP), an application specific integrated device, discrete gate or transistor logic, discrete hardware components, circuitry or any suitable combination thereof designed to perform the functions described herein. In this specification and the appended claims, it should be clear that the term “circuitry” is construed as a structural term and not as a functional term. For example, circuitry can be an aggregate of circuit components, such as a multiplicity of integrated circuit components, in the form of processing and/or memory cells, units, blocks, and the like, such as shown and described in FIG. 3. One or more of the functional blocks and/or one or more combinations of the functional blocks described with respect to the AT 106a may also be implemented as a combination of computing devices, e.g., a combination of a DSP and a microprocessor, a plurality of microprocessors, one or more microprocessor in conjunction with a DSP communication, or any other such configuration.

FIG. 4 is a functional block diagram of an exemplary packet data service node (PDSN) 225 shown in FIG. 2. As discussed above with respect to FIG. 2, the PDSN 225 may communicate with the BSC 220 to send/receive data to/from the AT 106a. Further, the PDSN 225 may communicate with the network 205 to send/receive data to/from the data source 202 as discussed above with respect to FIG. 2. Accordingly, the PDSN 225 may facilitate communication between the AT 106a and the data source 202. The PDSN 225 may comprise a transmit circuit 410 configured to transmit an outbound message, such as a request for data from the data source 202, to the network 205. The PDSN 225 may further comprise a receive circuit 415 configured to receive an incoming message, such as a data packet from the data source 202, from the network 205. The transmit circuit 410 and the receive circuit 415 may be coupled to a central processing unit (CPU)/controller 420 via a bus 417. The CPU 420 may be configured to process the inbound and outbound messages coming from or going to the network 205. The CPU 420 may also be configured to control other components of the PDSN 225.

The CPU 420 may further be coupled to a memory 430 via the bus 417. The CPU 420 may read information from or write information to the memory 430. For example, the memory 430 may be configured to store inbound or outbound messages before, during, or after processing. The memory 430 may also comprise instructions or functions for execution on the CPU 420. For example, the memory 430 may comprise the DPI 229. The operation of the CPU 420 executing each of the DPI 229 function is described below.

The DPI 229 may comprise instructions executable on the CPU 420. When executed by the CPU 420, the DPI 229 may cause the CPU 420 to process incoming/outgoing data packets. As discussed above with respect to FIG. 2 the DPI 229, for example, may be configured to inspect data packets received from the network 205 and direct them over the appropriate link to the AN 104a via the BSC 220. The DPI 229 may determine that the data packets from data source 202 require a particular QoS level. For example, the DPI 229 may detect a data packet (e.g., an IP packet) from the data source 202 comprising an indicator (e.g., an IP address) that uniquely identifies the data source 202. The DPI 229 may further comprise a table stored in memory 430 that matches the indicator to an indication of the appropriate QoS level (e.g., a DSCP value). Accordingly, the DPI 229 may mark the TOS field of the data packet's header with the associated DSCP value and send the data packet to the transmit circuit 410 for transmission to the AT 106a via the BSC 220.

The DPI 229 may further be configured to process one or more filter messages. For example, the PDSN 225 may receive a filter message at the transmit circuit 410. The filter message may be received from the AT 106a via the BSC 220 as discussed above with respect to FIG. 3. The filter message may comprise a mapping of a DSCP value to a profile identifier and/or a reservation label. In response to the filter message, the DPI 229 may direct the transmit circuit 410 to transmit data packets received from the data source 202 associated with received the DSCP value over a link with a QoS level associated with the received profile identifier and/or reservation label. Accordingly, the PDSN 225 transmits any data packets received from the data source 202 and/or associated with the received DSCP value over the appropriate link via the transmit circuit 410 to the AT 106a as discussed above with respect to FIG. 2.

The transmit circuit 410 may comprise a modulator configured to modulate outbound message going to the BSC 220 and/or the network 205. The receive circuit 415 may comprise a demodulator configured to demodulate inbound messages coming from the BSC 220 and/or the network 205.

The memory 430 may comprise processor cache, including a multi-level hierarchical cache in which different levels have different capacities and access speeds. The memory 430 may also comprise random access memory (RAM), other volatile storage devices, or non-volatile storage devices. The storage may include hard drives, optical discs, such as compact discs (CDs) or digital video discs (DVDs), flash memory, floppy discs, magnetic tape, Zip drives, etc.

Although described separately, it is to be appreciated that functional blocks described with respect to the PDSN 225 need not be separate structural elements. For example, the CPU 420 and the memory 430 may be embodied on a single chip. The CPU 420 may additionally, or in the alternative, contain memory, such as processor registers. Similarly, one or more of the functional blocks or portions of the functionality of various blocks may be embodies on a single chip. Alternatively, the functionality of a particular block may be implemented on two or more chips.

One or more of the functional blocks and/or one or more combinations of the functional blocks described with respect to the PDSN 225, such as the CPU 420 and the DPI 229, may be embodied as a general purpose processor, a digital signal processor (DSP), an application specific integrated device, discrete gate or transistor logic, discrete hardware components, circuitry or any suitable combination thereof designed to perform the functions described herein. As noted above, it should be clear that the term “circuitry” is construed as a structural term and not as a functional term. For example, circuitry can be an aggregate of circuit components, such as a multiplicity of integrated circuit components, in the form of processing and/or memory cells, units, blocks, and the like, such as shown and described in FIG. 4. One or more of the functional blocks and/or one or more combinations of the functional blocks described with respect to the AT 106a may also be implemented as a combination of computing devices, e.g., a combination of a DSP and a microprocessor, a plurality of microprocessors, one or more microprocessor in conjunction with a DSP communication, or any other such configuration.

FIG. 5 illustrates a table utilized by an exemplary quality of service (QoS) manager 227 shown in FIGS. 2 and 3. As discussed above with respect to FIGS. 2 & 3 the AT 106a may receive a data packet from the data source 202 via the PDSN 225. The PDSN 225 may add an indication of a QoS level for transmission of data packets to the AT 106a from the data source 202. The indication may comprise a DSCP value, which as discussed above with respect to FIG. 2 may be any arbitrary value. The QoS manager 227 running on the AT 106a may match the DSCP value to a profile identifier in order to generate a message to setup a filter at the PDSN 225 as discussed above with respect to FIG. 2. The filter may cause the PDSN 225 to send data packets from the data source 202 over a communication link that guarantees a particular QoS level. As discussed above with respect to FIG. 2, the profile identifier may uniquely identify the communication link between the AT 106a and the PDSN 225 that guarantees a particular QoS level. In order to generate the message, the QoS manager 227 may use the table 500 to match DSCP values to profile identifiers. The table 500 may be stored in the memory 330 of the AT 106a as noted above in FIG. 3. The QoS manager 227 may access the table 500 from the memory 330.

In one embodiment, the table 500 comprises X profile identifiers matched to X DSCP values. The value X is the number of QoS levels supported by the communication link 210 and/or the one or more links A1-A3. In one embodiment, X is equal to M×N where M is the number of data sources (e.g., content providers) from which the AT 106a receives data, and N is the number of services each data source provides (e.g., video stream, audio stream, etc.). As discussed above with respect to FIG. 2, the profile identifier may be directly associated with a particular QoS level. Accordingly, any given data packet from a data source may be matched to a particular QoS level via an assigned DSCP value and the matched profile identifier. Further, any given data source may have multiple DSCP values, one for each type of service provided. Accordingly, each service provided by the given data source may be assigned a different QoS level.

FIG. 6 illustrates exemplary logical data paths for the data pipes 215a-215c between the AT 106a and the AN 104a of FIG. 2. As discussed above with respect to FIG. 2, the AT 106a may receive data from the data source 202 via the AN 104a. The AT 106a may form a communication link 210 with the AN 104a. Further, the communication link 210 may comprise one or more data pipes 215-215c, which, as discussed above with respect to FIG. 2, may each comprise an airlink. Each data pipe may provide a particular QoS level. FIG. 6 schematically shows the data pipes 215a-215c in relation to a layer stack for communicating data over the communication link 210.

The data pipes 215a-215c may comprise a transport layer (e.g., transmission control protocol (TCP) layer, user datagram protocol (UDP) layer, etc.), an IP layer, a Point to Point Protocol (PPP) layer, one or more Radio Link Protocol (RLP) layers, and one or more Medium Access Control (MAC) layers. The transport layer may comprise a group of methods and protocols responsible for encapsulating data packets into data units suitable for transfer. The IP layer may comprise a group of methods and protocols used to transport data packets to a destination specified by a network address (e.g., IP address). The PPP layer may comprise a group of methods and protocols for interconnecting devices (e.g., the AT 106a and the AN 104a). The RLP layer may comprise a group of methods and protocols for detecting loss of data packets between devices and performing retransmissions. The MAC layer may comprise a group of methods and protocols for devices to communicate within a multipoint network (e.g., a network connecting multiple devices together).

Each layer in the layer stack configures the data to be sent via the communication link 210. As shown, all of the data pipes 215a-215c share the same Point to Point Protocol (PPP) layer, IP layer, and transport layer (e.g., transmission control protocol (TCP) layer, user datagram protocol (UDP) layer, etc.). Below the PPP layer, the data path for each of the data pipes 215a-215c is differentiated at the Radio Link Protocol (RLP) and the Medium Access Control (MAC) layers. The parameters configured at the MAC and RLP layers primarily determine the QoS level for the data traffic flowing on that RLP-MAC instance of the communication session. Accordingly, providing separate RLP and MAC layers for each of the data pipes 215a-215c accommodates a different QoS level for each data pipe 215a-215c.

FIG. 7 is an exemplary signal flow diagram illustrating signal flow between the AT 106a, the AN 104a, and the PDSN 225 of FIG. 2. As described above with respect to FIG. 2, the signal flow may be used to guarantee a QoS level for QoS Unaware applications running on the AT 106a receiving data from one or more data sources (e.g., the data source 202). The AT 106a, the AN 104a, and the PDSN 225 are shown horizontally at the top of the figure. The flow of various signals or data packets communicated between apparatuses is shown with directional arrows. The sequence of flow of signals occurs as time progresses. The progression of time is shown along the vertical axis of FIG. 7, with time starting at the top of the page and progressing down the page.

At a first step 703, the AT 106a powers up. After the AT 106a powers up, it may enter an initialization phase where it establishes a communication link with the PDSN 225. At a step 705, the AT 106a exchanges signals with the AN 104a to establish the communication link 210 with at least one data pipe (e.g., data pipe 215a) configured to carry BE data packets. Accordingly, the AT 106a negotiates a communication session/authorizes itself with the AN 104a. Further, at the step 707, the AN 104a exchanges signals with the PDSN 225 to establish at least one link (e.g., link A1) configured to carry BE data packets. Accordingly, the AN 104a registers a link (e.g., an A10 link) with the PDSN 225. Thus, a communication link is established between the AT 106a and the PDSN 225.

After the communication link is established between the AT 106a and the PDSN 225, a QoS Unaware application may be started at step 709. Accordingly, the QoS manager 227 instructs the AMSS 340 at step 711 to negotiate a PPP session with the PDSN 225 via the AN 104a in order for the AT 106a to request data from a data source (e.g., the data source 202) from the PDSN 225. Accordingly, at the step 713, the AT 106a negotiates a PPP session with the PDSN 225 via the AN 104a and requests data from the data source 202.

Further at a step 715, the QoS manager 227 initializes and instructs the AMSS 340 to send data packets received by the AT 106a to the QoS manager 227 so the QoS manager 227 may determine if the data packets comprise a DSCP value. At a next step 717, the QoS manager 227 receives a data packet from the PDSN 225 via the data pipe 215a and the link A1. The data packet comprises a DSCP value of D1 added to the data packet by the DPI 229 based on the source of the data packet as described above with respect to FIG. 2. Next, the QoS manager 227 matches the DSCP value D1 to the profile identifier P1 associated with an appropriate QoS level. Continuing at a step 719 the QoS manager 227 instructs the AMSS 340 to request a QoS level by setting up a filter at the PDSN 225 to direct data marked with the DSCP value D1 over links with the appropriate QoS level.

At a step 721, the AT 106a sets up a data pipe 215b on the communication link 210 with the AN 225. The data pipe 215b is configured to support the appropriate QoS level. Further, at a step 723, the AN 104a registers a link A2 with the PDSN 225. The link A2 is configured to support the appropriate QoS level. Next at a step 725, the AMSS 340 sets up the filter at the PDSN 225 to direct data marked with the DSCP value D1 over the link A2 and the data pipe 215b. In addition, at a step 727, the AMSS 340 and the AN 104a reserve the data pipe 215b for communication of data packets marked with the DSCP value D1. Continuing at a step 729, the AMSS 340 informs the QoS manager 227 that the QoS filter is activated. The AT 106a may continue to receive data packets from the PDSN 225. Further, the QoS manager 227 may inspect the incoming data packets for DSCP values.

Continuing at a step 731, the QoS Unaware application may deactivate. In one embodiment, if the QoS manager 227 does not detect an incoming data packet with the DSCP value D1 for a predetermined time interval, the QoS Unaware application may deactivate. In another embodiment, the QoS Unaware application deactivates when a user of the AT 106a deactivates the QoS Unaware application. Further, at a step 733, the QoS manager 227 may request the AMSS 340 deactivate or suspend the reservation of the data pipe 215b over the communication link 210 for data packets with the DSCP value D1. At a step 735, the AT 106a signals the AN 104a to deactivate or suspend the data pipe 215b. Further at the step 731, the AMSS 340 informs the QoS manager 227 the data pipe 215b has been deactivated or suspended.

One of ordinary skill in the art will recognize that one or more QoS Unaware applications may be activated and deactivated at various times on the AT 106a, triggering similar events to the steps described above with respect to FIG. 7.

FIG. 8 is flowchart of an exemplary process of transmitting data from a data source 202 to an AT 106a of FIG. 2. The process 800 is one embodiment of a process for transmitting data from the data source 202 to the AT 106a with a particular QoS level as discussed above with respect to FIG. 2. As discussed in connection with FIG. 2, the AT 106a may be configured to execute a QoS Unaware application (e.g., a software application that provides data content to a user of the AT 106a). The QoS Unaware application may request data from the data source 202 without specifying a desired QoS level. The process 800 represents a process of guaranteeing a QoS level for data content transmitted from the data source 202 to the AT 106a running the QoS Unaware application.

At a first step 805, the AT 106a transmits a request to the data source 202 seeking data from the data source 202. Continuing at a step 810, the PDSN 225 receives one or more data packets from the data source 202 in response to the transmitted request. Further, at a step 815, the PDSN 225 determines the origin of the received data packets. For example, the PDSN 225 may determine that the data packets were sent by the data source 202 by examining an IP address of the data packets. The examined IP address may belong to the data source 202. Next, at a step 820, the PDSN 225 determines whether a filter is setup for directing data packets from the data source 202 over a particular communication link. For example, as discussed above with respect to FIG. 2 and further below with respect to FIG. 9, the PDSN 225 may setup a filter that instructs the PDSN 225 to direct data packets from the data source 202 over a particular communication link. If the PDSN 225 determines that no filter is setup, the process 800 proceeds to the step 825. At the step 825, the PDSN 225 sets up a filter to direct data packets from the data source 202 over a particular communication link. The process 800 then returns to the step 810. If the PDSN 225 determines that a filter is setup, the process 800 proceeds to the step 830 where the PDSN 225 transmits the data packets from the data source 202 to the AT 106a over the communication link specified by the filter as discussed above with respect to FIG. 2.

FIG. 9 is a flowchart of an exemplary process of setting up a filter at a PDSN 225 for transmitting data received from a data source 202 to an AT 106a of FIG. 2. The process 900 illustrates in detail the step 825 of FIG. 8 for setting up a filter to direct data packets from the data source 202 to the AT 106a over a particular communication link that guarantees a particular QoS level.

At a first step 905, the PDSN 225 determines a QoS level associated with the data packets from the data source 202. For example, as discussed above with FIG. 2, the DPI module 229 of the PDSN 225 checks a table residing in the memory 440 of the PDSN 225. The table matches data sources to QoS levels. Continuing at a step 910, the PDSN 225 adds an indication of the QoS level determined at the step 905 to the data packets. For example, the PDSN 225 adds a DSCP value that maps to a QoS level as discussed above with respect to FIG. 2. At a next step 915, the PDSN 225 sends the data packets to the AT 106a.

At the step 920, the AT 106a inspects the received data packets for the indication of the QoS level. Continuing at the step 925, the AT 106a generates a filter message comprising the indication of the QoS level and an identifier of a communication link that guarantees communication at the QoS level. For example, the AT 106a may match the DSCP value in the data packets to a profile identifier as described above with respect to FIGS. 2 and 5. Further, the AT 106a may match the profile identifier to a reservation label that corresponds to the communication link. The AT 106a may access a table stored on the memory 330 of the AT 106a to match the DSCP value to the profile identifier. Further, the AMSS 340 may match the profile identifier to a reservation label for identifying the communication link based on the QoS level indicated by the profile identifier. Further, at a step 930, the AT 106a may transmit the generated message to the PDSN 225.

At a step 935, the PDSN 225 may reserve a data pipe 215b to direct data packets sent by the data source 202 from the AN 104a to the AT 106a as discussed above with respect to FIG. 2. Further, at a step 940, the PDSN 225 may reserve a link A2 to direct data packets sent by the data source 202 from the PDSN 225 to the AN 104a as discussed above with respect to FIG. 2. The data pipe 215b and the link A2 may guarantee communication at the QoS level. The PDSN 225 may access a table stored on the memory 430 of the PDSN 225 that matches profile identifiers and/or reservation labels to communication links such as the data pipe 215b and the link A2. Next, at a step 945, the PDSN 225 may setup a filter that configures the DPI 229 to transmit data packets sent by the data source 202 over the data pipe 215b and the link A2. Accordingly, the PDSN 225 is configured to send data packets sent by the data source 202 to the AT 106a over a communication link comprising the data pipe 215b and the link A2. The communication link guarantees the QoS level for the data packets sent by the data source 202.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of: A, B, or C” used in the description or the claims means “A or B or C or any combination of these elements.”

Those skilled in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those skilled in the art will further appreciate that the various illustrative logical blocks, modules, circuits, methods and algorithms described in connection with the examples disclosed herein may be implemented as electronic hardware, computer software, or combinations of both. To clearly illustrate this interchangeability of hardware and software, various illustrative components, blocks, modules, circuits, methods and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP communication, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor may read information from, and write information to, the storage medium. In the alternative, the storage medium may be integral to the processor. The processor and the storage medium may reside in an ASIC.

In one or more exemplary embodiments, the functions described may be implemented in hardware, software, firmware, or any combination thereof. If implemented in software, the functions may be stored as one or more instructions or code on a computer-readable medium. Computer-readable media includes computer storage media that facilitates transfer of a computer program from one place to another. A storage media may be any available media that can be accessed by a general purpose or special purpose computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Further, if implemented in software, the functions may be transmitted as one or more instructions or code over a transmission medium. A transmission medium may be any available connection for transmitting the one or more instructions or code. For example, if the software is transmitted from a website, server, or other remote source using a coaxial cable, fiber optic cable, twisted pair, digital subscriber line (DSL), then the coaxial cable, fiber optic cable, twisted pair, DSL, are included in the definition of transmission medium.

The previous description of the disclosed examples is provided to enable any person skilled in the art to make or use the present invention. Various modifications to these examples will be readily apparent to those skilled in the art, and the generic principles defined herein may be applied to other examples without departing from the spirit or scope of the invention. Thus, the present invention is not intended to be limited to the examples shown herein but is to be accorded the widest scope consistent with the principles and novel features disclosed herein.

What is claimed is:

1. A wireless communication apparatus operative in a communication network, the apparatus comprising:
a processor; and
circuitry coupled to the processor cooperatively configured to:
execute an application and receive content data for the application from a data source, wherein the application is unable to specify a quality of service (QoS) level for receiving the content data from the data source; and
specify the QoS level at which the application would receive the content data from the data source, wherein the specified QoS level is based at least in part on an identity of the data source.

2. The apparatus of claim 1, wherein the circuitry and the processor are further configured to: generate a message reserving a communication link for receiving the content data from the data source based at least in part on the QoS level; and direct transmission of the message to a communication device that is configured to send the content data from the data source.

3. The apparatus of claim 2, wherein the communication device comprises a server that is configured to set up a filter, and wherein the filter is configured to direct the content data from the data source over the communication link.

4. The apparatus of claim 1, wherein the circuitry and the processor are further configured to specify the QoS level based at least in part on a QoS level indicator, and wherein the content data comprises the QoS level indicator.

5. The apparatus of claim 4, wherein the circuitry and the processor are further configured to: store a database comprising one or more QoS level indicators corresponding to one or more QoS levels; and access the database to specify the QoS level.

6. The apparatus of claim 5, wherein the database comprises a table comprising a list of the one or more QoS level indicators corresponding to a list of one or more profile identifiers, wherein the one or more profile identifiers identify one or more QoS levels.

7. The apparatus of claim 4, wherein the QoS level indicator comprises a differentiated service code point (DSCP) value that corresponds to a profile identifier that corresponds to the QoS level.

8. The apparatus of claim 4, wherein the circuitry and the processor are further configured to receive the content data comprising a first data packet comprising the QoS level indicator, and the content data further comprising a second data packet comprising a different QoS level indicator, wherein the first data packet is received at the QoS level and the second data packet is received at a different QoS level.

9. The apparatus of claim 8, wherein the circuitry and the processor are further configured to: receive the first data packet during a first time period; and receive the second data packet at a second time period that is different than the first time period.

10. The apparatus of claim 1, wherein the circuitry comprises one or more of: a general purpose processor with instructions thereon, a digital signal processor, a application specific integrated circuit, a field programmable gate array, a programmable logic device, and a software module running on a computer.

11. A method of communicating between a wireless communication device and a data source, the method comprising:
executing an application;
receiving content data for the application from the data source, wherein the application is unable to specify a quality of service (QoS) level for receiving the content data from the data source; and
specifying the QoS level at which the application would receive the content data from the data source, wherein the specified QoS level is based at least in part on an identity of the data source.

12. The method of claim 11, further comprising:
generating a message reserving a communication link for receiving the content data from the data source based at least in part on the QoS level; and
directing transmission of the message to a communication device that is configured to send the content data from the data source to the application.

13. The method of claim 12, wherein the communication device comprises a server that is configured to set up a filter, and wherein the filter is configured to direct the content data from the data source to the application over the communication link.

14. The method of claim 11, further comprising specifying the QoS level based at least in part on a QoS level indicator, wherein the content data comprises the QoS level indicator.

15. The method of claim 14, further comprising:
storing a database comprising one or more QoS level indicators corresponding to one or more QoS levels; and
accessing the database to specify the QoS level.

16. The method of claim 15, wherein the database comprises a table comprising a list of the one or more QoS level indicators corresponding to a list of one or more profile identifiers, wherein the one or more profile identifiers identify one or more QoS levels.

17. The method of claim 14, wherein the QoS level indicator comprises a differentiated service code point (DSCP) value that corresponds to a profile identifier that corresponds to the QoS level.

18. The method of claim 14, further comprising receiving the content data comprising a first data packet comprising the QoS level indicator, the content data further comprising a second data packet comprising a different QoS level indicator, wherein the first data packet is received at the QoS level and the second data packet is received at a different QoS level.

19. The method of claim 18, further comprising:
receiving the first data packet during a first time period; and
receiving the second data packet at a second time period that is different than the first time period.

20. A wireless communication apparatus operative in a communication network, the apparatus comprising:
means for executing an application and for receiving content data for the application from a data source, wherein the application is unable to specify a quality of service (QoS) level for receiving the content data from the data source; and
means for specifying the QoS level at which the application would receive the content data from the data source, wherein the specified QoS level is based at least in part on an identity of the data source.

21. The apparatus of claim 20, wherein the executing means and the specifying means are cooperatively configured to: generate a message reserving a communication link for receiving the content data from the data source based at least in part on the QoS level; and direct transmission of the message to a communication device that is configured to send the content data from the data source.

22. The apparatus of claim 21, wherein the communication device comprises a server that is configured to set up a filter, and wherein the filter is configured to direct the content data from the data source over the communication link.

23. The apparatus of claim 20, wherein executing means and the specifying means are cooperatively configured to specify the QoS level based at least in part on a QoS level indicator, and wherein the content data comprises the QoS level indicator.

24. A computer program product, comprising:
computer-readable medium comprising:
code for causing a computer to execute an application;
code for causing a computer to receive content data for the application from a data source, wherein the application is unable to specify a quality of service (QoS) level for receiving the content data from the data source; and
code for causing a computer to specify the QoS level at which the application would receive the content data from the data source, wherein the specified QoS level is based at least in part on an identity of the data source.

25. The computer program product of claim 24, wherein the computer-readable medium further comprises:
code for causing a computer to generate a message reserving a communication link for receiving the content data from the data source based at least in part on the QoS level; and
code for causing a computer to direct transmission of the message to a communication device that is configured to send the content data from the data source to the application.

26. The computer program product of claim 25, wherein the communication device comprises a server that is configured to set up a filter, and wherein the filter is configured to direct the content data from the data source to the application over the communication link.

27. The computer program product of claim 24, wherein the computer-readable medium further comprises code for causing a computer to specifying the QoS level based at least in part on a QoS level indicator, wherein the content data comprises the QoS level indicator.

28. A communication apparatus operative in a communication network, the apparatus comprising:
a receiver configured to receive from a wireless communication device a request for content data from a data source, wherein the wireless communication device is configured to execute an application and receive the content data for the application from the data source, wherein the application is unable to specify a quality of service (QoS) level for receiving the content data from the data source;
a processor coupled to the receiver, the processor being configured to associate with the data source a configurable QoS level at which the wireless communication device would receive the content data from the data source; and
a transmitter coupled to the processor, the transmitter being configured to transmit an indication of the associated QoS level to the wireless communication device, wherein the wireless communication device is configured to specify the QoS level at which the application would receive the content data from the data source based at least in part on the transmitted indication of the associated QoS level.

29. The apparatus of claim 28, wherein the processor is further configured to select a first QoS level as the configurable QoS level for a first time period and select a second QoS level as the configurable QoS level for a second time period that is different than the first time period.

30. The apparatus of claim 28, wherein the receiver is further configured to receive a message from the wireless communication device reserving a communication link for transmitting the content data from the data source based at least in part on the QoS level, and wherein the transmitter is further configured to transmit the content data from the data source to the wireless communication device.

31. The apparatus of claim 28, wherein the indication of the associated QoS level comprises a differentiated service code point (DSCP) value that corresponds to a profile identifier that corresponds to the QoS level.

32. The apparatus of claim 28, wherein the transmitter is further configured to transmit the content data comprising a first data packet comprising the indication of the associated QoS level, and the content data further comprising a second data packet comprising a different indication of the associated QoS level, wherein the first data packet is transmitted at the QoS level and the second data packet is transmitted at a different QoS level.

33. The apparatus of claim 32, wherein the transmitter is further configured to: transmit the first data packet during a first time period; and transmit the second data packet at a second time period that is different than the first time period.

34. A method of communicating between a wireless communication device and a data source, the method comprising:
receiving from the wireless communication device a request for content data from the data source, wherein the wireless communication device is configured to execute an application and receive the content data for the application from the data source, wherein the application is unable to specify a quality of service (QoS) level for receiving the content data from the data source;
associating with the data source a configurable QoS level at which the wireless communication device would receive the content data from the data source; and
transmitting an indication of the associated QoS level to the wireless communication device, wherein the wireless communication device is configured to specify the QoS level at which the application would receive the content data from the data source based at least in part on the transmitted indication of the associated QoS level.

35. The method of claim 34, further comprising:
selecting a first QoS level as the configurable QoS level for a first time period; and
selecting a second QoS level as the configurable QoS level for a second time period that is different than the first time period.

36. The method of claim 34, further comprising:
receiving a message from the wireless communication device reserving a communication link for transmitting the content data from the data source based at least in part on the QoS level; and
transmitting the content data from the data source to the wireless communication device.

37. The method of claim 34, wherein the indication of the associated QoS level comprises a differentiated service code point (DSCP) value that corresponds to a profile identifier that corresponds to the QoS level.

38. The method of claim 34, further comprising transmitting the content data comprising a first data packet comprising the indication of the associated QoS level, and the content data further comprising a second data packet comprising a different indication of the associated QoS level, wherein the first data packet is transmitted at the QoS level and the second data packet is transmitted at a different QoS level.

39. The method of claim 38, further comprising:
transmitting the first data packet during a first time period; and
transmitting the second data packet at a second time period that is different than the first time period.

40. A wireless communication apparatus operative in a communication network, the apparatus comprising:
means for receiving from a wireless communication device a request for content data from a data source, wherein the wireless communication device is configured to execute an application and receive the content data for the application from the data source, wherein the application is unable to specify a quality of service (QoS) level for receiving the content data from the data source;
means for associating with the data source a configurable QoS level at which the wireless communication device would receive the content data from the data source; and
means for transmitting an indication of the associated QoS level to the wireless communication device, wherein the wireless communication device is configured to specify the QoS level at which the application would receive the content data from the data source based at least in part on the transmitted indication of the associated QoS level.

41. The apparatus of claim 40, wherein the associating means is further configured to select a first QoS level as the configurable QoS level for a first time period and select a second QoS level as the configurable QoS level for a second time period that is different than the first time period.

42. The apparatus of claim 40, wherein the receiving means is further configured to receive a message from the wireless communication device reserving a communication link for transmitting the content data from the data source based at least in part on the QoS level, and wherein the transmitting means is further configured to transmit the content data from the data source to the wireless communication device.

43. A computer program product, comprising:
computer-readable medium comprising:
code for causing a computer to receive from a wireless communication device a request for content data from the data source, wherein the wireless communication device is configured to execute an application and receive the content data for the application from the data source, wherein the application is unable to specify a quality of service (QoS) level for receiving the content data from the data source;
code for causing a computer to associate with the data source a configurable QoS level at which the wireless communication device would receive the content data from the data source; and
code for causing a computer to transmit an indication of the associated QoS level to the wireless communication device, wherein the wireless communication device is configured to specify the QoS level at which the application would receive the content data from the data source based at least in part on the transmitted indication of the associated QoS level.

44. The computer program product of claim 43, wherein the computer-readable medium further comprises:
code for causing a computer to select a first QoS level as the configurable QoS level for a first time period; and
code for causing a computer to select a second QoS level as the configurable QoS level for a second time period that is different than the first time period.

45. The computer program product of claim 43, wherein the computer-readable medium further comprises:
code for causing a computer to receive a message from the wireless communication device reserving a communication link for transmitting the content data from the data source based at least in part on the QoS level; and
code for causing a computer to transmit the content data from the data source to the wireless communication device.
